(19) United States
(12) Patent Application Publication
(10) Pub. No.: US 2023/0379787 A1
(43) Pub. Date: Nov. 23, 2023

(54) METHOD AND APPARATUS FOR REQUESTING CONDITIONAL HANDOVER, AND STORAGE MEDIUM, TERMINAL AND BASE STATION

(71) Applicant: SPREADTRUM COMMUNICATIONS (SHANGHAI) CO., LTD., Shanghai (CN)

(72) Inventor: Lifeng HAN, Pudong New Area, Shanghai (CN)

(21) Appl. No.: 18/028,365

(22) PCT Filed: Sep. 17, 2021
(86) PCT No.: PCT/CN2021/118972

§ 371 Date: Mar. 24, 2023

(30) Foreign Application Priority Data
Sep. 25, 2020 (CN) 202011024082.5

(51) Int. Cl. H04W 36/36; H04W 36/32; H04W 36/00

(52) U.S. Cl. CPC H04W 36/362; H04W 36/324; H04W 36/0079

(57) ABSTRACT

A method and apparatus for requesting conditional handover, a storage medium, a terminal and a base station are provided. The method includes: reporting conditional handover assistance information to assist a base station to determine whether a terminal adopts conditional handover; wherein the conditional handover assistance information indicates that the terminal requests conditional handover.

### CROSS REFERENCE TO RELATED APPLICATIONS

This is the U.S. national stage of application No. PCT/CN2021/118972, filed on Sep. 17, 2021. Priority under 35 U.S.C. § 119(a) and 35 U.S.C. § 365(b) is claimed from Chinese Application No. 202011024082.5, filed on Sep. 25, 2020, the disclosure of which is also incorporated herein by reference.

### TECHNICAL FIELD

The present disclosure generally relates to communication technology field, and more particularly, to a method and apparatus for requesting conditional handover, a storage medium, a terminal, and a base station.

### BACKGROUND

In current 5G communication systems, technical solutions of conditional handover have been introduced. For the conditional handover, a source base station is instructed to configure execution conditions for User Equipment (UE) to hand over to one or more target cells, and the UE assesses the execution condition. If the execution condition of the conditional handover is met, the UE performs handover to the corresponding target cell.

### SUMMARY

Embodiments of the present disclosure provide a method and apparatus for requesting conditional handover, a storage medium, a terminal, and a base station, which may enhance information interaction between a terminal and a base station and improve a success rate of handover.

In an embodiment of the present disclosure, a method for requesting conditional handover is provided, including reporting conditional handover assistance information to assist a base station to determine whether a terminal adopts conditional handover; wherein the conditional handover assistance information indicates that the terminal requests conditional handover.

In an embodiment of the present disclosure, a storage medium having computer instructions stored therein is provided, wherein when the computer instructions are executed by a processor, the above method is performed.

In an embodiment of the present disclosure, a terminal including the above apparatus or including a memory and a processor is provided, wherein the memory has computer instructions stored therein, and when the processor executes the computer instructions, the above method is performed.

### BRIEF DESCRIPTION OF THE DRAWINGS

FIG. 1 is a data flow diagram of a method for requesting conditional handover in existing techniques;

FIG. 2 is a flow chart of a method for requesting conditional handover according to an embodiment;

FIG. 3 is a flow chart of S22 as shown in FIG. 2 according to an embodiment;

FIG. 4 is a flow chart of S22 as shown in FIG. 2 according to an embodiment; and

FIG. 5 is a flow chart of a method for requesting conditional handover according to an embodiment.

### DETAILED DESCRIPTION

As described in the background, in existing conditional handover techniques, a base station configures conditional handover for a terminal in a relatively simple way, resulting in a waste of network resources in some cases, and a handover failure in other cases.

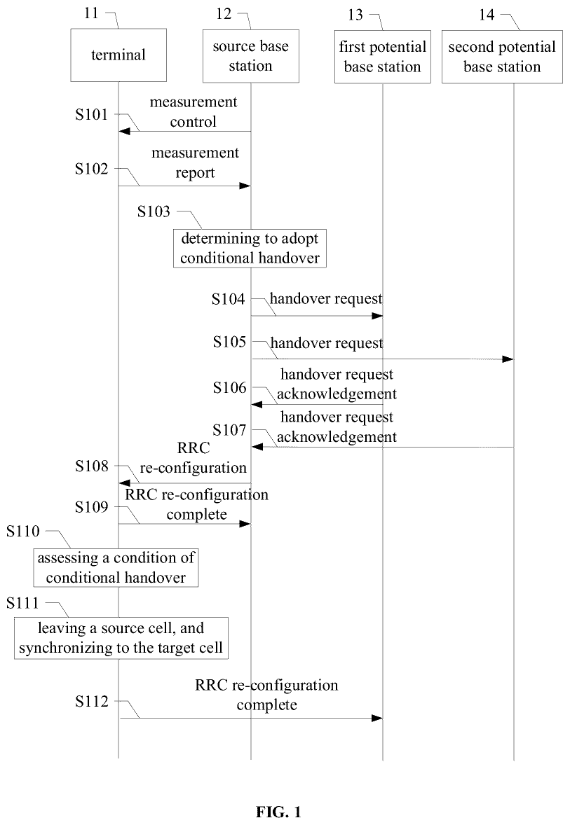

Referring to FIG. 1, FIG. 1 is a data flow diagram of a method for requesting conditional handover in existing techniques. The method includes S101 to S112. Each step is described as follows.

In S101, a source base station 12 transmits measurement control to a terminal 11. Specifically, the source base station 12 transmits measurement configuration to the terminal 11, for example, including a measurement event A3 and/or event A5, wherein the event A3 means that signal quality of a neighboring cell is higher than signal quality of a serving cell by an offset value, and the event A5 means that the signal quality of the serving cell is lower than a threshold value 1 and the signal quality of the neighboring cell is higher than a threshold value 2.

In S102, the terminal 11 reports a measurement report to the source base station 12, wherein the measurement report may be triggered by an event or reported by the terminal periodically.

In S103, the source base station 12 determines to adopt conditional handover. Specifically, the source base station 12 determines that conditional handover needs to be performed, for example, based on the measurement report and Radio Resource Management (RRM).

In S104, the source base station 12 transmits a handover request message to a first potential target base station 13, requesting to handover the terminal 11 to the first potential target base station 13.

In S105, the source base station 12 transmits a handover request message to a second potential target base station 14, requesting to handover the terminal 11 to the second potential target base station 14.

In S106, the first potential target base station 13 feeds back a handover request acknowledgement message which indicates that the first potential target base station 13 agrees to handover the terminal 11 to the first potential target base station 13. The handover request acknowledgement message may also include resource configuration information for the terminal 11 to perform random access in a target cell of the first potential target base station 13.

In S107, the second potential target base station 14 feeds back a handover request acknowledgement message which indicates that the second potential target base station 14 agrees to handover the terminal 11 to the second potential target base station 14. The handover request acknowledgement message may also include resource configuration information for the terminal 11 to perform random access in a target cell of the second potential target base station 14.

In S108, the source base station 12 transmits a Radio Resource Control (RRC) reconfiguration (RRCReconfiguration) message to the terminal 11. The RRC reconfiguration message includes at least one candidate target cell of conditional handover and at least one execution condition of conditional handover, for example, may include multiple candidate target cells and corresponding execution conditions of conditional handover.

In S109, the terminal 11 transmits an RRC reconfiguration complete (RRCReconfigurationComplete) message to the source base station 12.

In S110, the terminal 11 assesses a condition of conditional handover. Specifically, the terminal 11 assesses conditions of conditional handover of multiple candidate target cells. If at least one candidate target cell meets the corresponding execution condition of conditional handover, handover to the target cell is performed.

In S111, the terminal 11 performs handover to the target cell, leaves a source cell, and synchronizes to the target cell, that is, performing random access in the target cell.

In S112, the terminal 11 transmits an RRC reconfiguration complete message to the target base station (for example, the first potential target base station 13).

Inventors of the present disclosure have found through research that in existing conditional handover techniques, the base station either configures conditional handover for all terminals in a cell, or does not configure conditional handover for any terminals. Specifically, if all the terminals in the cell are configured with conditional handover, it may cause a waste of network resources, as multiple target base stations configure resources for multiple terminals, and a waste of data packet forwarding between the source base station and the target base station. If no conditional handover is configured for a terminal, the terminal may hand over too late, resulting in a handover failure or a radio link failure, which leads to degraded performance.

In the embodiments of the present disclosure, by reporting conditional handover assistance information to assist a base station to determine whether a terminal adopts conditional handover, the terminal may determine whether it is inclined to adopt conditional handover, which improves engagement of the terminal. Further, by the reporting step, information interaction between the terminal and the base station may be increased. Compared with existing techniques where a base station determines whether to set conditional handover for a terminal according to the base station's own judgment, the embodiments of the present disclosure improve a success rate of handover.

In order to clarify the objects, characteristics and advantages of the disclosure, embodiments of present disclosure will be described in detail in conjunction with accompanying drawings.

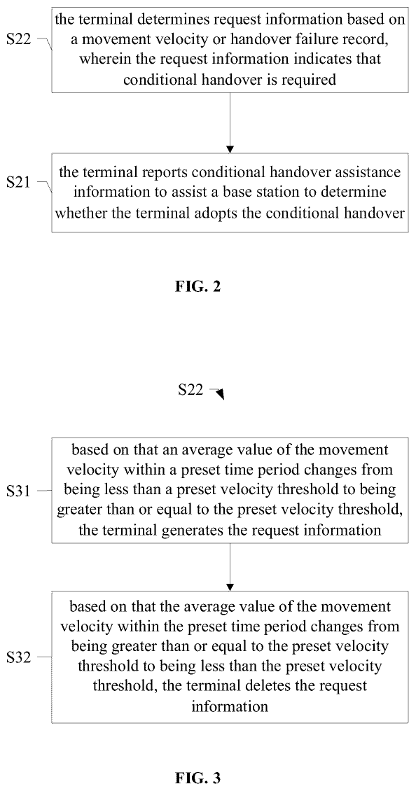

Referring to FIG. 2, FIG. 2 is a flow chart of a method for requesting conditional handover according to an embodiment. The method for requesting conditional handover may be applied to a terminal and include S21.

In S21, the terminal reports conditional handover assistance information to assist a base station to determine whether the terminal adopts conditional handover.

The conditional handover assistance information indicates that the terminal requests conditional handover.

In the embodiment, by reporting conditional handover assistance information to assist a base station to determine whether a terminal adopts conditional handover, the terminal may determine whether it is inclined to adopt conditional handover, which improves engagement of the terminal. Further, by the reporting step, information interaction between the terminal and the base station may be increased. Compared with existing techniques where a base station determines whether to set conditional handover for a terminal according to the base station's own judgment, the embodiments of the present disclosure improve a success rate of handover.

In some embodiments, the conditional handover assistance information includes: one or more target cells for which the terminal requests conditional handover.

In the embodiments, by configuring to report one or more target cells for which the terminal requests conditional handover in the conditional handover assistance information, information interaction between the terminal and the base station may be increased, to make the base station determine a target cell where the terminal is inclined to adopt conditional handover. Compared with existing techniques where a base station determines whether to set conditional handover for a terminal according to the base station's own judgment, the embodiments of the present disclosure further improve the success rate of handover.

In some embodiments, before S21, the method may further include receiving indication information which instructs the terminal to report the conditional handover assistance information; wherein the conditional handover assistance information is reported in response to receiving the indication information.

In the embodiment of the present disclosure, by setting the step of receiving indication information before reporting the conditional handover assistance information, the base station can determine when the terminal needs to report, thereby effectively reducing signaling overhead.

Further, the indication information may be notified to the terminal through an RRC dedicated message or an RRC common message (such as system information).

Further, the terminal may report the conditional handover assistance information through an RRC message.

Further, the RRC message may include but not limited to RRCSetupComplete, RRCResumeComplete, RRCReconfigurationComplete, RRCReestablishmentComplete, and UEAssistanceInformation.

Further, the terminal may report the conditional handover assistance information in scenarios such as an RRC connected state, a dual connection state, and a process of entering an RRC connected state.

The method may further include S22 before S21.

In S22, the terminal determines request information based on a movement velocity or handover failure record, wherein the request information indicates that conditional handover is required.

Further, S21 may include reporting the conditional handover assistance information based on the request information.

In the embodiments of the present disclosure, by determining the request information based on the movement velocity or the handover failure record, the terminal determines whether it is inclined to adopt conditional handover using an appropriate parameter, thereby improving accuracy and effectiveness of determination by the terminal, and further improving engagement of the terminal. This is conducive to further improving the success rate of handover. Further, the base station may realize personalized configuration based on indication of different terminals, which helps to reduce a waste of network resources.

It could be understood that, in some embodiments, the method may be implemented in form of a software program which runs in a processor integrated in a chip or a chip module.

Referring to FIG. 3, FIG. 3 is a flow chart of a specific implementation of S22 as shown in FIG. 2 according to an embodiment. Said determining the request information based on the movement velocity may include S31 and S32 each of which is described below.

In S31, based on that an average value of the movement velocity within a preset time period changes from being less than a preset velocity threshold to being greater than or equal to the preset velocity threshold, the terminal generates the request information.

In S32, based on that the average value of the movement velocity within the preset time period changes from being greater than or equal to the preset velocity threshold to being less than the preset velocity threshold, the terminal deletes the request information.

Further, in the method as shown in FIG. 3, said reporting the conditional handover assistance information based on the request information includes: in response to receiving the indication information, reporting the conditional handover assistance information based on existence of the request information; and in response to receiving the indication information, not reporting the conditional handover assistance information based on absence of the request information.

Specifically, the terminal may determine according to its own movement velocity, for example, if the terminal is in a high-velocity moving state or in a medium-velocity moving state, the terminal reports the conditional handover assistance information, indicating that the terminal is inclined to adopt conditional handover.

Further, a determination standard of the high-velocity or medium-velocity moving state may be predefined in communication standards or may be set by a network side and notified to the terminal or may be determined by the terminal itself.

In the embodiments of the present disclosure, said determining request information based on a movement velocity includes based on that an average value of the movement velocity within a preset time period changes from being less than a preset velocity threshold to being greater than or equal to the preset velocity threshold, generating the request information. In this manner, the terminal reports to request conditional handover based on the request information that haven't been deleted yet merely when receiving indication information at a relatively high velocity, while effectively avoiding excessive setting of conditional handover at a relatively low velocity.

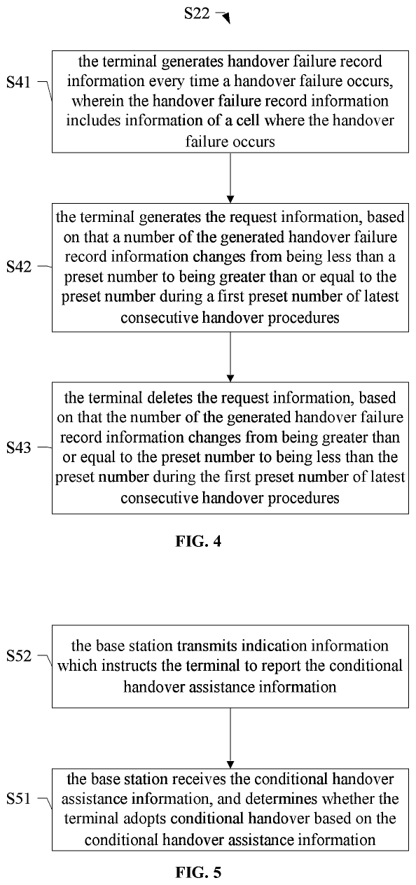

Referring to FIG. 4, FIG. 4 is a flowchart of another specific implementation of S22 as shown in FIG. 2 according to an embodiment. Said determining the request information based on the handover failure record may include S41 to S43 each of which is described below.

In S41, the terminal generates handover failure record information every time a handover failure occurs, wherein the handover failure record information includes information of a cell where the handover failure occurs.

In S42, the terminal generates the request information, based on that a number of the generated handover failure record information changes from being less than a preset number to being greater than or equal to the preset number during a first preset number of latest consecutive handover procedures.

In S43, the terminal deletes the request information, based on that the number of the generated handover failure record information changes from being greater than or equal to the preset number to being less than the preset number during the first preset number of latest consecutive handover procedures.

In the embodiments of the present disclosure, said determining request information based on handover failure record includes generating handover failure record information every time a handover failure occurs; generating the request information, based on that a number of the generated handover failure record information changes from being less than a preset number to being greater than or equal to the preset number during a first preset number of latest consecutive handover procedures. In this manner, the terminal reports to request conditional handover based on the request information that haven't been deleted yet merely when receiving indication information in a case that handover failures occur for a relatively great number of times, while effectively avoiding excessive setting of conditional handover in response to few handover failures.

Further, prior to reporting the conditional handover assistance information, the method further includes looking up all the handover failure record information; determining a historical number of handover failures from a current cell to a target cell based on information of cells in all the handover failure record information; and generating the request information based on that the historical number is greater than or equal to a second preset number.

In some embodiments, the terminal may use technologies such as artificial intelligence to identify a scene where handover fails, so as to report the conditional handover assistance information, indicating that the terminal is inclined to adopt the conditional handover. For example, if the terminal passes through a same area multiple times, and there is a high probability that handover failure will occur when handing over from a current cell to a target cell, the terminal may identify that it is about to enter the area, the terminal reports the conditional handover assistance information.

In the embodiments of the present disclosure, the terminal may make determination based on historical data. For example, if handover from the current cell to the target cell fails for multiple times, the conditional handover assistance information is reported to indicate that the terminal is inclined to adopt the conditional handover. In case of few handover failures, excessive setting of conditional handover may be effectively avoided.

Further, the handover failure may be determined based on any one of the following: a radio link failure occurring in a cell before too-late handover, and RRC re-establishment being performed in a cell after the too-late handover, where the too-late handover refers to handover that occurs too late and should have occurred from a previous cell to a latter cell; or a failure occurring during too-late handover and RRC re-establishment being triggered, wherein a target cell of the RRC re-establishment is a handover target cell of the handover failure, where the too-late handover refers to handover that occurs too late, during which the handover fails and RRC re-establishment is performed in the target cell.

Specifically, the above-mentioned handover failure event can also be called a too-late handover event. Taking a handover from Cell 1 to Cell 2 as an example, the too-late handover event may include that the terminal has a radio link failure in Cell 1 and performs RRC re-establishment in Cell 2, or the terminal fails in a handover from Cell 1 to Cell 2 and triggers RRC re-establishment, wherein a target cell Cell 2 for RRC re-establishment is a handover target cell Cell 2 of the handover failure.

In the embodiments of the present disclosure, after the terminal reports the conditional handover assistance information, the base station may use the conditional handover assistance information from the terminal to perform measurement configuration or handover decision.

Specifically, the base station may perform measurement configuration after receiving the conditional handover assistance information from the terminal. If the terminal indicates that conditional handover is preferred, the base station may configure measurement events with different thresholds for the terminal, such as a trigger threshold of A3 event or a trigger threshold of A5 event, so that the measurement event A3/A5 can be triggered more easily.

Further, if the conditional handover assistance information also includes a list of target cells for which it is inclined to perform conditional handover, the base station may only configure measurement events with different thresholds for the target cells, such as a trigger threshold of A3 event or a trigger threshold of A5 event. The measurement event A3/A5 for the target cells can be triggered more easily.

Further, after receiving a measurement report from the terminal, the base station may take the conditional handover assistance information received from the terminal into consideration when determining whether to adopt the conditional handover. Exemplarily, if the terminal is inclined to adopt the conditional handover, the base station determines to adopt the conditional handover. Otherwise, the base station may determine whether to adopt the conditional handover based on other information contained in the measurement report.

In the embodiments of the present disclosure, based on the conditional handover assistance information from the terminal, the base station can more accurately configure measurement configuration, or more accurately make a decision on the conditional handover.

Referring to FIG. 5, FIG. 5 is a flow chart of a method for requesting conditional handover according to an embodiment. The method may be applied to a base station and include S51.

In S51, the base station receives conditional handover assistance information, and determines whether a terminal adopts conditional handover based on the conditional handover assistance information.

The conditional handover assistance information indicates that the terminal requests conditional handover.

Further, the conditional handover assistance information may include one or more target cells for which the terminal requests conditional handover.

Further, the conditional handover assistance information may be reported by the terminal based on request information, and the request information is determined based on a movement velocity or handover failure record and indicates that conditional handover is required.

More details about determining the request information based on the movement velocity or the handover failure record can be found in the above descriptions and are not repeated here.

Prior to S51, the method further includes S52.

In S52, the base station transmits indication information which instructs the terminal to report the conditional handover assistance information.

The conditional handover assistance information is reported in response to receiving the indication information.

More details of S51 and S52 can be referred to related descriptions of S21 in FIG. 1 and are not repeated here.

In an embodiment, an apparatus for requesting conditional handover is provided, including: a reporting circuitry configured to report conditional handover assistance information to assist a base station to determine whether a terminal adopts conditional handover; wherein the conditional handover assistance information indicates that the terminal requests conditional handover.

Principles, specific implementations and advantages of the apparatus can be referred to related descriptions of the method as described in the above context and in FIGS. 2 to 4 and are not repeated here.

In an embodiment of the present disclosure, an apparatus for requesting conditional handover is provided, including: a receiving circuitry configured to receive conditional handover assistance information, and determine whether a terminal adopts conditional handover based on the conditional handover assistance information: wherein the conditional handover assistance information indicates that the terminal requests conditional handover.

In some embodiments, the apparatus may correspond to a chip with a data processing function, or to a chip module including a chip with a data processing function, or to the UE.

Principles, specific implementations and advantages of the apparatus can be referred to related descriptions of the method as described in the above context and in FIG. 5 and are not repeated here.

The technical solutions of the present disclosure can be applied to 5G communication systems, 4G and 3G communication systems, and various new communication systems in the future, such as 6G and 7G communication systems.

In an embodiment of the present disclosure, a storage medium having computer instructions stored therein is provided, wherein when the computer instructions are executed by a processor, the above method is performed. In some embodiments, the storage medium may be a computer readable storage medium and may include a non-volatile or a non-transitory memory, or include an optical disk, a mechanical disk or a solid disk.

In the embodiments of the present disclosure, the processor may be a Central Processing Unit (CPU), or other general processors, Digital Signal Processors (DSPs), Application Specific Integrated Circuits (ASICs), Field Programmable Gate Arrays (FPGAs) or other Programmable logic devices, discrete gates or transistor logic devices, discrete hardware components, and the like. A general processor may be a microprocessor, or the processor may be any conventional processor or the like.

It should also be understood that the memory in the embodiments of the present disclosure may be either volatile memory or nonvolatile memory or may include both volatile and nonvolatile memories. The non-volatile memory may be a Read-Only Memory (ROM), a Programmable ROM (PROM), an Erasable PROM (EPROM), an electrically Erasable EPROM (EEPROM), or a flash memory. The volatile memory may be a Random Access Memory (RAM) which functions as an external cache. By way of example hut not limitation, various forms of RAM are available, such as Static Random Access Memory (SRAM). Dynamic Random Access Memory (DRAM), Synchronous Dynamic Random Access Memory (SDRAM), Double Data Rate Synchronous Dynamic Random Access Memory (DDR S DRAM), Enhanced SDRAM (ESDRAM), Synchronous connection to DRAM (SLDRAM), and Direct Rambus RAM (DR-RAM).

In an embodiment of the present disclosure, a terminal including a memory and a processor is provided, wherein the memory has computer instructions stored therein, and when the processor executes the computer instructions, the above method is performed. The terminal may include but not limited to a mobile phone, a computer or a tablet computer.

The terminal in the embodiments of the present disclosure may refer to various forms of UE, access terminal, user unit, user station, Mobile Station (MS), remote station, remote terminal, mobile equipment, user terminal, terminal equipment, wireless communication equipment, user agent or user device. The terminal equipment may further be a cellular phone, a cordless phone, a Session initiation Protocol (SIP) phone, a Wireless Local Loop (WLL) station, a Personal Digital Assistant (PDA), a handheld device with a wireless communication function, a computing device or other processing devices connected to a wireless modems, an in-vehicle device, a wearable device, a terminal equipment in the future 5G network, or a terminal equipment in a future evolved Public Land Mobile Network (PLMN), which is not limited in the embodiments of the present disclosure.

In an embodiment of the present disclosure, a base station including a memory and a processor is provided, wherein the memory has computer instructions stored therein, and when the processor executes the computer instructions, the above method is performed.

The Base Station (BS) in the embodiments of the present disclosure may also be referred to as a base station equipment, and is an apparatus deployed in a wireless access network to provide wireless communication functions. For example, an equipment that provides a base station function in a 2G network includes a Base Transceiver Station (BTS). An equipment that provides the base station function in a. 3G network includes a Node B. An equipment that provides the base station function in a 4G network includes an evolved Node B (eNB). In a Wireless Local Area Network (WLAN), an equipment that provides the base station function is an Access Point (AP). An equipment that provides the base station function in 5G New Radio (NR) includes a gNB and an ng-eNB, where the gNB and the terminal use NR technology to communicate, and the ng-eNB and the terminal use Evolved Universal Terrestrial Radio Access (E-UTRA) technology to communicate. Both the gNB and the ng-eNB can be connected to a 5G core network. The base station also refers to an equipment that provides the base station function in a new communication system in the future.

The base station controller in the embodiments of the present disclosure is a device for managing base stations, such as a Base Station Controller (BSC) in a 2G network, a Radio Network Controller (RNC) in a 3G network, or a device that controls and manages a base station in a new communication system in the future.

The network in the embodiments of the present disclosure refers to a communication network that provides communication services for terminals, including a base station of a radio access network, a base station controller of a radio access network, and a device on a core network side.

Each module/unit of each apparatus and product described in the above embodiments may be a software module/unit or a hardware module/unit or may be a software module/unit in part, and a hardware module/unit in part. For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for requesting conditional handover, comprising:
reporting conditional handover assistance information to assist a base station to determine whether a terminal adopts conditional handover;
wherein the conditional handover assistance information indicates that the terminal requests conditional handover.

2. The method according to claim 1, wherein the conditional handover assistance information comprises:
one or more target cells for which the terminal requests conditional handover.

3. The method according to claim 1, wherein prior to reporting the conditional handover assistance information, the method further comprises:
receiving indication information which instructs the terminal to report the conditional handover assistance information;
wherein the conditional handover assistance information is reported in response to receiving the indication information.

4. The method according to claim 1, wherein prior to reporting the conditional handover assistance information, the method further comprises:
determining request information based on a movement velocity or handover failure record, wherein the request information indicates that conditional handover is required;
wherein said reporting the conditional handover assistance information comprises reporting the conditional handover assistance information based on the request information.

5. The method according to claim 4, wherein said determining request information based on a movement velocity comprises:
based on that an average value of the movement velocity within a preset time period changes from being less than a preset velocity threshold to being greater than or equal to the preset velocity threshold, generating the request information; and
based on that the average value of the movement velocity within the preset time period changes from being greater than or equal to the preset velocity threshold to being less than the preset velocity threshold, deleting the request information.

6. The method according to claim 4, wherein said reporting the conditional handover assistance information based on the request information comprises:
in response to receiving the indication information, reporting the conditional handover assistance information based on existence of the request information; and
in response to receiving the indication information, not reporting the conditional handover assistance information based on absence of the request information.

7. The method according to claim 4, wherein said determining request information based on handover failure record comprises:
generating handover failure record information every time a handover failure occurs, wherein the handover failure record information comprises information of a cell where the handover failure occurs;
generating the request information, based on that a number of the generated handover failure record information changes from being less than a preset number to being greater than or equal to the preset number during a first preset number of latest consecutive handover procedures; and
deleting the request information, based on that the number of the generated handover failure record information changes from being greater than or equal to the preset number to being less than the preset number during the first preset number of latest consecutive handover procedures.

8. The method according to claim 7, wherein prior to reporting the conditional handover assistance information, the method further comprises:
looking up all the handover failure record information;
determining a historical number of handover failures from a current cell to a target cell based on information of cells in all the handover failure record information; and
generating the request information based on that the historical number is greater than or equal to a second preset number.

9. The method according to claim 7, wherein the handover failure is determined based on any one of the following:
a radio link failure occurring in a cell before too-late handover, and RRC re-establishment being performed in a cell after the too-late handover; or
a failure occurring in too-late handover and RRC re-establishment being triggered, wherein a target cell of the RRC re-establishment is a handover target cell of the handover failure.

10-15. (canceled)

16. A non-transitory storage medium storing one or more programs, the one or more programs comprising computer instructions, which, when executed by a processor, cause the processor to:
report conditional handover assistance information to assist a base station to determine whether a terminal adopts conditional handover;
wherein the conditional handover assistance information indicates that the terminal requests conditional handover.

17. A terminal comprising a memory and a processor, wherein the memory stores one or more programs, the one or more programs comprising computer instructions, which, when executed by the processor, cause the processor to:
report conditional handover assistance information to assist a base station to determine whether a terminal adopts conditional handover;
wherein the conditional handover assistance information indicates that the terminal requests conditional handover.

18. (canceled)

19. The terminal according to claim 17, wherein the conditional handover assistance information comprises:
one or more target cells for which the terminal requests conditional handover.

20. The terminal according to claim 17, wherein the processor is further caused to:
prior to reporting the conditional handover assistance information, receive indication information which instructs the terminal to report the conditional handover assistance information;
wherein the conditional handover assistance information is reported in response to receiving the indication information.

21. The terminal according to claim 17, wherein the processor is further caused to:
prior to reporting the conditional handover assistance information, determine request information based on a movement velocity or handover failure record, wherein the request information indicates that conditional handover is required;
wherein said reporting the conditional handover assistance information comprises reporting the conditional handover assistance information based on the request information.

22. The terminal according to claim 21, wherein the processor is further caused to:
based on that an average value of the movement velocity within a preset time period changes from being less than a preset velocity threshold to being greater than or equal to the preset velocity threshold, generate the request information; and
based on that the average value of the movement velocity within the preset time period changes from being greater than or equal to the preset velocity threshold to being less than the preset velocity threshold, delete the request information.

23. The terminal according to claim 21, wherein the processor is further caused to:
in response to receiving the indication information, report the conditional handover assistance information based on existence of the request information; and
in response to receiving the indication information, not report the conditional handover assistance information based on absence of the request information.

24. The terminal according to claim 21, wherein the processor is further caused to:
generate handover failure record information every time a handover failure occurs, wherein the handover failure record information comprises information of a cell where the handover failure occurs;
generate the request information, based on that a number of the generated handover failure record information changes from being less than a preset number to being greater than or equal to the preset number during a first preset number of latest consecutive handover procedures; and
delete the request information, based on that the number of the generated handover failure record information changes from being greater than or equal to the preset number to being less than the preset number during the first preset number of latest consecutive handover procedures.

25. The terminal according to claim 24, wherein the processor is further caused to:
prior to reporting the conditional handover assistance information, look up all the handover failure record information;
determine a historical number of handover failures from a current cell to a target cell based on information of cells in all the handover failure record information; and
generate the request information based on that the historical number is greater than or equal to a second preset number.

26. The terminal according to claim 24, wherein the handover failure is determined based on any one of the following:
a radio link failure occurring in a cell before too-late handover, and RRC re-establishment being performed in a cell after the too-late handover; or
a failure occurring in too-late handover and RRC re-establishment being triggered, wherein a target cell of the RRC re-establishment is a handover target cell of the handover failure.
